(19) United States
(12) Patent Application Publication
(10) Pub. No.: US 2005/0033836 A1
(43) Pub. Date: Feb. 10, 2005

(54) Terminal-based instruction execution in an ip communications network

(76) Inventors: Heikki Tuunanen, Espoo (FI); Markus Martin, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/492,151

(22) PCT Filed: Oct. 11, 2002
(86) PCT No.: PCT/IB02/04417

(30) Foreign Application Priority Data
Oct. 11, 2001 (GB) 0124436.7

(51) Int. Cl. G06F 15/173

(52) U.S. Cl. 709/224; 709/225

(57) ABSTRACT

A method of handling events in a communications system including an IP-based network; the method comprising the steps of: (a) receiving and storing in an Internet Protocol Terminal Equipment (IPTE) at least one event and corresponding default handling instruction, the event and default handling instruction being supplied by the network; (b) receiving in the IPTE an event notification during a session or session setup between the network and the IPTE, the event notification corresponding to one of the events stored in the IPTE; and (c) executing in the IPTE the default instruction corresponding to the event to which the event notification responds.

### FIELD OF INVENTION

The present invention relates to the field of packet-based telecommunications, and Internet Protocol (IP) telecommunications in general.

The invention has primarily been developed for use in wireless telecommunications networks complying with proposed and future versions of the third-generation (3G) and General Packet Radio Systems (GPRS) standards, and will be described hereinafter with reference to this application. However, it will be appreciated by those skilled in the art that the invention can be applied in other contexts.

### BACKGROUND TO INVENTION

In the presently proposed 3G standards, an Internet Protocol Terminal Equipment (IPTE) initiates or receives a call by negotiating with a Call State Control Function (CSCF) or SIP server located within an associated communications network. During establishment of a call (or other communication, such as forwarding data, documents, images or the like), and during the call itself, various call-handling information is passed between the CSCF and the IPTE. Such call handling information includes messages informing of busy or redirection signals, and call termination by the other party.

When such events occur during call setup, there is often a requirement for a default interaction between the IPTE and the network For example, if a party being called by the IPTE is busy, a default tone is played back to the caller through the IPTE. Similarly, if a call is redirected, a voice and/or text announcement to this effect can be made to the user through the IPTE.

The tasks that need to be executed when these events are encountered may be standardised, or can be configurable by the network operator or the user of the IPTE. If a standardised response is required (eg, a busy tone if the intended recipient's handset is engaged), then the IPTE knows by default what has to be done. For this to work, it is necessary that the events and the tasks associated with them are standardized so that network operators and manufacturers of IPTEs know precisely the response of the IPTE for a particular event notification.

If there is no standardised action for a given event within a call or session, the network needs to be configured to perform the required task itself. For example, if an intended recipient is busy, the required announcement can be generated within the network and downloaded to the IPTE as required. The only capability required of the IPTE for this action is that of connecting to an end point (an announcement device in this example). This requires that a PDP context for real time operation be built and that the resources of the both the radio access network and the GPRS network be reserved for the duration of the announcement.

It would be desirable to reduce the amount of real-time network-to-IPTE connection required for event handling.

### SUMMARY OF INVENTION

In a first aspect of the invention, there is provided a method of handling events in a communications system including an IP-based network, the method comprising the steps of:
(a) receiving and storing in an Internet Protocol Terminal Equipment (IPTE) at least one event and corresponding default handling instruction, the event and default handling instruction being supplied by the network;
(b) receiving in the IPTE an event notification during a session or session setup between the network and the IPTE, the event notification corresponding to one of the events stored in the IPTE; and
(c) executing in the IPTE the default instruction corresponding to the event to which the event notification responds.

Preferably, the events and their corresponding instructions are received from a Call State Control Function (CSCF) located within the network. It is particularly preferred that the events and their corresponding instructions are received from the CSCF during CSCF registration.

Preferably, one or more data objects are also received from the network, the data objects being for use with or by the instructions. The data objects can be, for example, one or more of the following: text; voice; still images; video images; sounds.

In one preferred form, the method includes:
receiving a request from the network, enquiring as to the event handling capabilities of the IPTE; and
sending a message from the IPTE informing the network of its event handling capabilities;
wherein the events and instructions received by the IPTE in step (a) are selected by the network on the basis of the message.

In a second aspect, the invention provides an Internet Protocol Terminal Equipment (IPTE) for use in a communications system including an IP-based network, the IPTE being configured to handle events in the communication system and including:
(a) receiving means for receiving at least one event and corresponding default handling instruction, the event and default handling instruction being supplied by the network;
(b) memory for storing the event and default handling instruction;
(c) processing means for executing the default instruction;
   corresponding to the event to which the event notification responds;
   the IPTE being configured such that, upon receiving from the network an event notification corresponding to an event in the memory, the processor executes the default instruction corresponding to that event.

Preferably, the IPTE is configured to receive the events and their corresponding instructions from a Call State Control Function (CSCF) located within the network. More preferably, the events and their corresponding instructions are received from the CSCF during CSCF registration.

Preferably, the IPTE is configured to receive one or more data objects from the network and store them in the memory, the data objects being for use with or by the instructions. The data objects can include, for example, one or more of the following: text; voice; still images; video images; sounds.

Preferably, the IPTE is configured to:
receive a request from the network, enquiring as to the event handling capabilities of the IPTE; and
send a message informing the network of its event handling capabilities;
wherein the events and instructions received by the IPTE are selected by the network on the basis of the message.

### BRIEF DESCRIPTION OF DRAWINGS

A preferred embodiment of the invention will now be described, by way of example only, with reference to the accompanying drawings, in which:

FIG. 1 is a flowchart showing the steps involved in a first embodiment of a method of handling events in a communications system, in accordance with the invention;

FIG. 2 is a flowchart showing the steps involved in a second embodiment of the invention; and

FIG. 3 is a schematic view of an IPTE for implementing the invention, in conjunction with a network.

### DETAILED DESCRIPTION OF PREFERRED EMBODIMENT

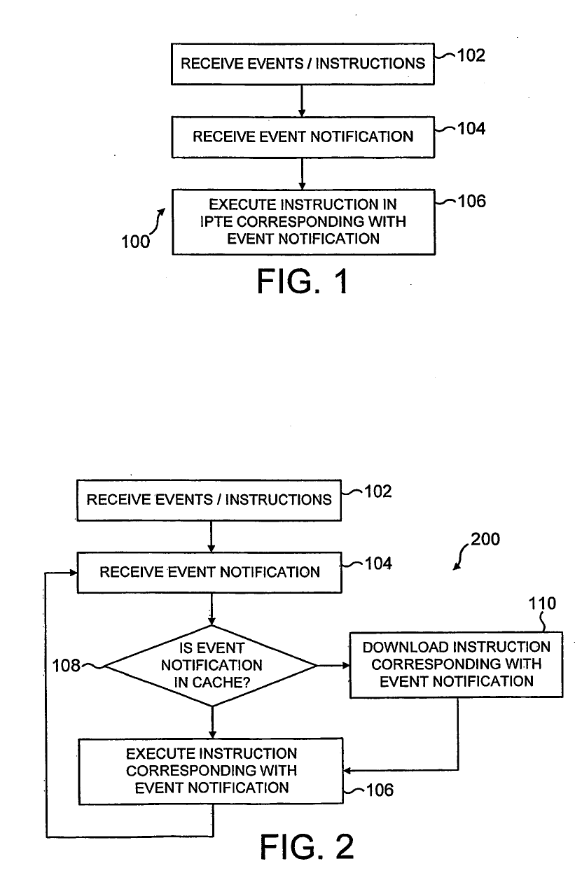

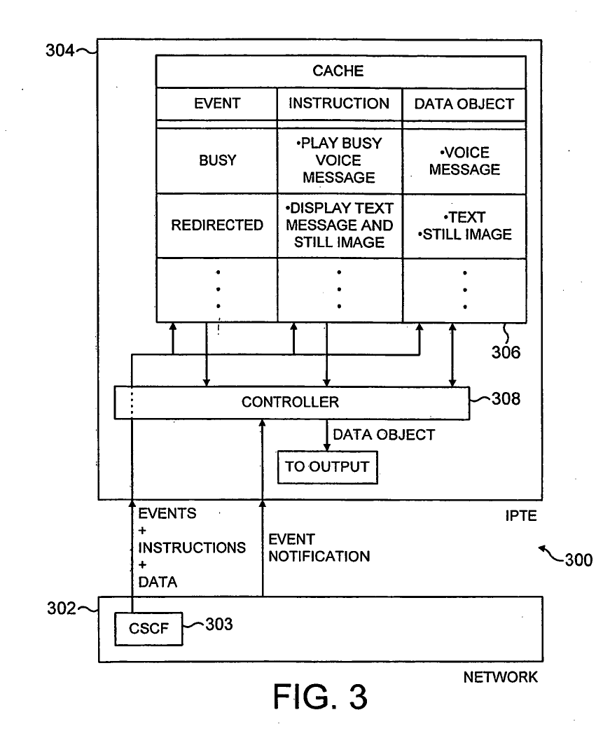

Referring to FIGS. 1 and 3, in the simplest form of the invention, there is provided a method 100 of handling events in a communications system 300 including an IP-based network 302. The network includes a Call State Control Function (CSCF) 303 which maintains a list of default events that may need to be handled. For each event, the CSCF also includes one or more associated instructions that define an associated response.

Events include any situation in which a state of a call or session changes. The following is a non-exhaustive list of events:
Busy;
No answer;
Not registered on network;
Call rejected;
Call forwarded/proxied;
Prepaid account empty.

Events can also involve multiple changes of state, such as, for example, a username/password transaction with multiple messages between network and IPTE. Each message in such a transaction can be considered a separate event, although the entire sequence could be considered an event requiring a number of sub-steps.

An Internet Protocol Terminal Equipment (IPTE) in the form of a mobile telephone 304 is configured with a memory 306 connected to a controller 308. It will be appreciated that the controller 308 can either be specialised to the task described below, or (more likely) is a CPU and associated circuitry within the IPTE 304. Similarly, the memory can be a cache dedicated for use in the application described below, or can take the form of general memory on the IPTE that is managed by the controller 308.

In use, the IPTE 304 receives (step 102) one or more events and their associated instructions from the network 302, and stores them in the memory 306. In the preferred form, this is done at a random or predetermined time that is not during establishment of a call or session. In the embodiment shown, two specific events are given as examples: busy (ie, the intended receiver is engaged) and redirected (ie, the intended receiver is redirecting calls).

The IPTE also receives data objects corresponding with the various instructions it receives. In the present example, the busy instruction requires a voice message object, and the redirected instruction requires a text message and a still image. In the preferred embodiment, these are received by the IPTE along with the events and instructions, and then stored in memory.

The events and corresponding instructions are received and stored by the IPTE before they are actually required. For example, they can be downloaded automatically during registration of the IPTE with the CSCF. In a particularly preferred embodiment, this downloading takes place outside peak network periods, or at a low priority. However, it is not necessary that this be the case, and the events and instructions can be downloaded at any convenient time.

During establishment of a session, or during the session once a call has been established, events that have been stored in the IPTE memory can occur. For example, whilst trying to establish a call, it may be that the intended recipient of the call is already talking to someone else. In that event, it is necessary to notify the user of the IPTE that this has happened. A “busy” event notification is then sent from the network 302 to the IPTE 304. Once received (step 104), the controller ascertains that the busy event notification has a match with the busy event in memory, and therefore executes (step 106) the instruction associated with the busy event stored in memory.

The instruction associated with the busy event is to play a “busy” voice message, which in turn is stored as a voice data object. The controller takes the correct voice message and replays it through the earpiece of the IPTE for the user to hear. The mechanism by which this occurs is well known to those skilled in the art, and so is not described here in detail.

The user hangs up and attempts to dial the recipient again later. This time, the recipient's telephone is set to redirect calls to a voicemail box, and so the network informs the IPTE of this by way of a “Redirected” event notification. Again, the controller looks up the correct entry in memory and executes the associated instruction (show image and display text) with reference to the requisite data objects (still image and text in memory).

It can be seen that by storing events and instructions in the IPTE prior to when they are needed, it is possible to reduce the amount of traffic required to implement notifications to the user of the IPTE in real time. This can be particularly important during peak network usage periods. Downloading the requisite data objects and storing them in the IPTE before they are required allows even greater savings in real-time bandwidth.

There are a number of alternative embodiments that provide increased functionality. One such embodiment is shown in FIG. 2, in which similar steps are indicated with corresponding numerals. In that embodiment, it is not assumed that every event notification sent by the network is stored in IPTE memory. Therefore, it is necessary to make a comparison (step 108) with the events in memory to ascertain whether that event (and therefore its corresponding instruction) is available. If it is, then the method behaves as described in relation to embodiment of FIG. 1. However, if the event corresponding with the event notification is not found in the IPTE memory, it is necessary to obtain the required instructions from the network (step 110). This can be achieved by sending a suitable SIP (for example) request to the network.

In its response, the network can provide the instruction and associated data objects, or the addresses of either or both on the network. For example, the data might be stored on a server in the network The SIP message received from the network in response to the request for instructions and data might include the instructions themselves, along with a URL from which the data can be downloaded or streamed to the IPTE for display to the user.

The second embodiment takes into account the fact that not all IPTEs will be capable of holding all possible events and their associated instructions. This may be for any number of reasons, such as limited memory on the IPTE, use of memory for other purposes, or simply the need to accommodate large numbers of events and instructions.

Where there is a limitation on the number of events and instructions that can be stored on the IPTE, it is preferred that the network prioritises the defaults events that will be downloaded to IPTEs. In that way, each IPTE can accept as many events as it can handle and reject the remaining lower priority events. In some cases, it can be of assistance to the IPTE making such a decision if the sizes of particular instructions are provided with the event list.

The events and associated instructions (and data objects when provided) can be sent to the IPTE in a number of ways. In the preferred embodiment, this is done out of call context using FTP or another suitable data transfer protocol. In a 3G system, the events, instructions and data objects can be sent using Best Effort Quality, which is a low priority form of communication.

In yet other embodiments, the CSCF queries the IPTE (typically upon CSCF registration) to ascertain the capabilities of the IPTE as regards event handling. This can include, for example, the number of events the IPTE can store and the amount of memory available for the data objects (if they are to be stored on the IPTE). Also, the IPTE may not be capable of dealing with certain types of data. For example, the IPTE may not be capable of playing back videos, or of displaying certain types of image. Alternatively, the IPTE may prefer to receive data objects in certain formats, perhaps matching its output characteristics. For example, if the IPTE has a monochrome 640 by 480 screen, it is clearly desirable to provide the data objects in a corresponding format.

Such capability queries can also be handled using SIP messaging. For example, when the IPTE registers with the CSCF using the SIP REGISTER method, the CSCF returns the events and corresponding instructions in an SIP RESPONSE message.

Alternatively, the CSCF can send to the IPTE a URL indicating an address from which the IPTE can retrieve the instructions and/or data at some other time. Each event could have it's own URL or a common URL can be provided at which all events to be downloaded to a particularly IPTE or type of IPTE are stored. The network element to which the URL points can be an Application Server (APSE), the CSCF itself or Home Subscriber Server. The event list and associated URL(s) can be conveyed as a payload in the SIP response. In the scenario described, the SIP response message would be “2000K”.

In yet other embodiments, the IPTE can initiate retrieval of events itself. For example, the IPTE can send an SIP INVITE to a CSCF or an APSE, the CSCF or APSE responding with a list of events for which instructions can be sent to the IPTE in the body of a “200 OK” SIP response.

It will be appreciated that there may be several potential instructions for each event, depending upon, for example, the capabilities of the IPTE. The different possibility can be provided to the IPTE with the events, and the IPTE can then choose an appropriate instruction from a number of available instructions.

In some cases, it is desirable for the instructions to include directions on call handling, as well as informing the user as described above. For example, an instruction sequence might cause a tone to be played, then request further information (such as username and password) from a user, which are in turn communicated to a network server via SIP. In another example, if the intended recipient of a call is busy, the instructions can terminate the SIP session immediately and then proceed with instructions that inform the user of what has happened.

The instructions can also include indications such as a “time-to-live” parameter, which specifies the period of time for which the instructions are valid.

It will be appreciated that there are a number of ways in which SIP messaging can be used by the IPTE and/or the network to communicate with each other. For example, particular SIP messages can be interpreted as events. An example would be an informational SIP, such as a “181:Call is being forwarded” message being interpreted as a call forwarded event for the purpose of executing corresponding instructions within the IPTE. The possible messages under SIP are well known to those skilled in the art, and so additional examples are not given in this specification.

Although the invention has been described with reference to a number of specific embodiments, it will be appreciated by those skilled in the art that the invention can be embodied in many other forms.

1. A method of handling events in a communications system including an IP-based network, the method comprising the steps of:
(a) receiving and storing in an Internet Protocol Terminal Equipment (IPTE) at least one event and corresponding default handling instruction, the event and default handling instruction being supplied by the network;
(b) receiving in the IPTE an event notification during a session or session setup between the network and the IPTE, the event notification corresponding to one of the events stored in the IPTE; and
(c) executing in the IPTE the default instruction corresponding to the event to which the event notification responds.

2. A method according to claim 1, wherein the events and their corresponding instructions are received from a Call State Control Function (CSCF) located within the network.

3. A method according to claim 2, wherein the events and their corresponding instructions are received from the CSCF during CSCF registration.

4. A method according to claim 1, wherein the events and their corresponding instructions are received or updated from the CSCF automatically when no session is established.

5. A method according to claim 4, wherein the receiving or updating occurs during an off-peak period for radio traffic in the network.

6. A method according to claim 1, further including the step of receiving one or more data objects from the network, the data objects being for use with or by the instructions.

7. A method according to claim 1, wherein the data objects include one or more of the following:
text;
voice;
still images;
video images;
sounds.

8. A method according to claim 7, wherein one or more of the instructions in the IPTE includes a reference to a corresponding one or more of data objects.

9. A method according to any one of the preceding claims claim 1, further including the step of receiving, as required, events and instructions in real time during a session, in the case that those events and instructions are not stored in the IPTE.

10. A method according to claim 9, wherein data associated with events and instructions received during a session is also received during that session.

11. A method according to claim 1, wherein events and corresponding instructions received by and stored in the IPTE are relatively common events.

12. A method according to claim 1, further including the steps, prior to step (a), of:
receiving a request from the network, enquiring as to the event handling capabilities of the IPTE; and
sending a message from the IPTE informing the network of its event handling capabilities;
wherein the events and instructions received by the IPTE in step (a) are selected by the network on the basis of the message.

13. A method according to claim 12, wherein the request and message are in accordance with the Session Initiation Protocol (SIP) standard.

14. A method according to claim 1, further including the step of requesting from the network an event and corresponding instruction for storage within the IPTE.

15. An Internet Protocol Terminal Equipment (IPTE) for use in a communications system including an IP-based network, the IPTE being configured to handle events in the communication system and including:
(a) receiving means for receiving at least one event and corresponding default handling instruction, the event and default handling instruction being supplied by the network;
(b) memory for storing the event and default handling instruction;
(c) processing means for executing the default instruction;
corresponding to the event to which the event notification responds;
the IPTE being configured such that, upon receiving from the network an event notification corresponding to an event in the memory, the processor executes the default instruction corresponding to that event.

16. An IPTE according to claim 15, configured to receive the events and their corresponding instructions from a Call State Control Function (CSCF) located within the network.

17. An IPTE according to claim 16, wherein the events and their corresponding instructions are received from the CSCF during CSCF registration.

18. An IPTE according to claim 15, the IPTE and/or the network being configured such that the events and their corresponding instructions are received or updated from the CSCF automatically when no session is established.

19. An IPTE according to claim 18, wherein the receiving or updating occurs during an off-peak period for radio traffic in the network.

20. An IPTE according to claim 15, configured to receive one or more data objects from the network and store them in the memory, the data objects being for use with or by the instructions.

21. An IPTE according to claim 15, wherein the data objects include one or more of the following:
text;
voice;
still images;
video images;
sounds.

22. An IPTE according to claim 21, wherein one or more of the instructions in the IPTE includes a reference to a corresponding one or more of data objects.

23. An IPTE according to claim 15, configured to receive, as required, events and instructions in real time during a session, in the case that those events and instructions are not stored in the IPTE.

24. An IPTE according to claim 23, wherein data associated with events and instructions received during a session is also received during that session.

25. An IPTE according to claim 15, wherein events and corresponding instructions received by and stored in the IPTE are relatively common events.

26. An IPTE according to claim 15, configured to:
receive a request from the network, enquiring as to the event handling capabilities of the IPTE; and
send a message informing the network of its event handling capabilities;
wherein the events and instructions received by the IPTE are selected by the network on the basis of the message.

27. An IPTE according to claim 26, wherein the request and message are in accordance with the Session Initiation Protocol (SIP) standard.

28. An IPTE according to claim 15, configured to request from the network an event and corresponding instruction for storage within the IPTE.
